(19) United States
(12) Patent Application Publication
(10) Pub. No.: US 2004/0058302 A1
(43) Pub. Date: Mar. 25, 2004

(54) System and method for more efficient computer aided career and/or vocational choice and/or decision making

(76) Inventors: Yaron Mayer, Jerusalem (IL); Itamar Gati, Jerusalem (IL)

Correspondence Address: YARON MAYER, 21 AHAD HAAM ST., JERUSALEM, IL

(21) Appl. No.: 10/421,876

(22) Filed: Apr. 24, 2003

Related U.S. Application Data
(63) Continuation-in-part of application No. 10/086,216, filed on Feb. 20, 2002.
Application No. 10/086,216 is a continuation-in-part of application No. PCT/IL01/00572, filed on Jun. 24, 2001.
(63) Continuation-in-part of application No. 10/328,088, filed on Dec. 20, 2002.
(60) Provisional application No. 60/376,235, filed on Apr. 24, 2002.
(60) Provisional application No. 60/214,003, filed on Jun. 26, 2000.
(60) Provisional application No. 60/359,554, filed on Feb. 19, 2002.
(60) Provisional application No. 60/370,631, filed on Apr. 2, 2002.
(60) Provisional application No. 60/376,235, filed on Apr. 24, 2002.

(30) Foreign Application Priority Data
Jun. 22, 2000 (IL) 136945
Apr. 24, 2002 (IL) 149320

(51) Int. Cl. G06F 17/60; G09B 19/00

(52) U.S. Cl. 434/219; 705/14

(57) ABSTRACT

Programs for computer aided career choice have existed already for at least 20 years, however they were typically either based on Sequential Elimination, which suffers from a number of problems (such as for example distortions of weights, more sensitivity to judgment errors, and having to rank-order the questions in advance), or on compensational methods, which typically suffer from other problems. On the other hand, sequential elimination has the advantage of immediate feedback at each step, so the implications of the user's decisions in filling each aspect (question) are clear to him/her immediately after filling the aspect, whereas it is much more difficult to give such immediate feedback after each step when compensation is used. Another problem, which is common to both elimination and compensation methods, is that the computer vocational guidance systems that exist today may ask the user the importance for each aspect in the user's eyes, but do not take into account also the importance or core-ness of the aspects (questions) from the point of view the vocation. The present invention tries to solve many of the above problems, takes into consideration also the core-ness of the aspects, enables receiving immediate feedback also when compensation is used, and introduces many additional improvements over the current state of the art. Although the main examples used are regarding vocational choice, the same or similar principles or at least some of these features can be used also for other multiple choice targets (potential choices) where there are multiple aspects, such as for example buying or renting a house or a car, etc.

### BACKGROUND OF THE INVENTION

1. Field of the Invention

The present invention relates to computer aided career choice, and more specifically to a system and method for computer aided career and/or vocational choice and/or other types of decision making where there are multiple possible choice targets and multiple aspects, such as for example choosing a university or college, buying or renting a car, buying or renting an apartment or house, etc., based on a large number of improvements over the current state of the art.

2. Background

Programs for computer aided career choice have existed already for at least 20 years, however they were typically either based on Sequential Elimination, which suffers from a number of problems, or on compensational methods, which typically suffer from other problems.

Sequential elimination suffers from: 1. A distortion of weights because each aspect (question) that enters the process becomes automatically of absolute importance, even if it was not assigned absolute importance. 2. The cutting point—between aspects that finally entered the process and aspects that finally didn't enter it—creates an additional distortion so that each question that entered becomes more important than the sum of all the remaining unused aspects altogether. 3. Another problem is that this method is more sensitive to judgment errors (for example by the experts who define the database of vocations), since even one such mistake can rule out a vocation. 4. Another problem is that various arbitrary decisions typically have to be made, for example in order to force the process to end at a predefined stage, such as for example if the number of remaining vocations becomes lower than a certain threshold, or to force the process to continue because too many vocations still remain, etc. 5. In order to enable the process, the user typically has to first rank the aspects by order of importance, which is a difficult task which creates cognitive burden because for each aspect ranked the user has to compare it in his mind with all the other aspects. 6. Also, ranking aspects before viewing their options in more detail might be more difficult, since it is more natural to first choose the desired options in the aspect, and then define its importance. 7. The sequential elimination method is more restrictive and less tolerant to people who have diverse interests and/or tendencies, since each additional tendency might rule out a vocation that fulfills another tendency, whereas compensation in this case can lower the absolute scores of the top compatible vocations but not rule them out. (However, even compensation only solves this problem partially). On the other hand, sequential elimination has the advantage of immediate feedback at each step, so the implications of the user's decisions in filling each aspect are clear to him/her immediately after filling the aspect.

Compensation is based on a scoring system so that each aspect that is fulfilled can typically increase the compatibility score, so if an aspect was not fulfilled, it can still be compensated for if enough other aspects are fulfilled. In better systems, this is based also on the importance assigned by the user to each aspect. This solves the distortion problems of the sequential elimination, however there are some other problems: 1. It is difficult to give the user feedback until the process of filling the questionnaire is finished, so in the existing systems the user sees the results of his/her choice only after finishing to fill all the questions. 2. Purely compensational methods go to the other extreme, since they don't allow the user to specify that one or more aspects are of absolute importance, which means that the user does not wish to compromise about them under any circumstances, in other words, no amount of other fulfilled aspects can compensate for them. 3. The definition of importance is not absolutely clear, since for example the user might understand it as referring to “how important it is that this aspect is fulfilled in the optimal level (or levels)” or “how important it is that this aspect is fulfilled in the acceptable levels”. 4. It is hard to know the exact ratio that the user had in mind or that should be used between highly important aspects to low importance aspect, but knowing this ratio is important for correctly computing the scores.

Another problem, which is common to both elimination and compensation methods, is that the computer vocational guidance systems that exist today may ask the user the importance for each aspect in the user's eyes, but do not take into account also the importance or core-ness of the aspects from the point of view of the vocation.

### SUMMARY OF THE INVENTION

The present invention tries to solve many of the above problems in better ways. A hybrid system (called “Meshiv”) which includes both Sequential elimination and compensation has been developed by the authors of the present invention already many years ago. However, the present invention introduces many improvements over the existing system and over other systems in the current state of the art.

The improved system and method preferably contain at least some of the following features:

1. Preferably the user is given more immediate feedback about the results of his choices even when using a compensatory method. This can be accomplished for example by letting the user view after filling each aspect (or for example after each group of aspects) the resulting list of most compatible vocations according to the aspects already filled by him. This is similar to viewing the list of remaining vocations after each step of the sequential elimination, except that unlike the sequential elimination, in which the list can only grow smaller (or stay the same) after each step, in this case the vocations in the top list simply change. The list itself might grow or become shorter, depending on the cutting point criterion, so that for example if a certain absolute threshold is used, more or less vocations might be included. Another possible variation is that the list is kept for example at a constant size, by simply showing at each step for example the most compatible 20 vocations, preferably in descending order of compatibility. Another possible variation is that the list is prevented from going below a minimal size and/or above a maximal size, or for example is kept within a certain range according to various criteria. For example the list size can be limited between a minimum of 10 vocations and a maximum of 30, and the exact size determined for example according to some absolute and/or relative criteria of score level. These methods of determining the list size can be used for example at any stage where the user can view the least and/or when showing the final list. Another possible variation is to use for example various marks and/or colors and/or separate grouping into sub-lists in order to indicate to the user at each step for example which vocations are new-additions to the top list at the current step and/or which vocations have moved out of the list at the current step, and/or which vocations have been most stable on the list already for a number of steps, and/or to summarize for the user numerically how many vocations were added to the top list (for example the top 20) and/or how many moved out of the top list at this step and/or how significant the changes are from the previous step. Another possible variation is to give this feedback not after every step of filling an aspect, but for example after every few aspects and/or each time there is a significant change in the list, and/or for example at any step but only if and when the user requests it. Similarly, if the user makes any changes for example in the characterization of an aspect and/or in the importance of an aspect, the user can again preferably be given such immediate feedback (preferably this is done both when changes are made during the filling process and also if they are made afterwards). On the other hand, this has the disadvantage that if the user starts for example with less important aspects, the results of the first lists can be quite misleading. In order to solve this problem, there are a number of possible solutions, such as for example to ask the user to specify the importance in advance (or at least for the more important aspects in his eyes), and/or to rank the aspects, like in the sequential elimination, except that at each step compensatory rules are used instead of elimination (preferably except for aspects where the user marked absolute importance) (if the user is only asked to define the importances, preferably the ranking is generated automatically from the importances as defined by the user and/or for example by taking into account also known importances from previous statistics and/or previous users and/or the core-ness scores, at least for example for internal sorting among aspects to which the user gave the same importance). However, this still has the disadvantage that it is less natural to define weights or ranking before filling the actual desired and acceptable levels of the aspect. Another possible variation is to order the aspects in advance according to their importance, for example as generated automatically from the vocations data, so that for example the aspects are ordered in descending order of core-ness (in other words, each aspect is positioned according to the number of vocations in which it is a core aspect, and/or for example according to the largest sum of values, if the core-ness code is not binary), and/or for example according to importance data from previous users, so that for example the aspects with the highest average importances across users appear first, and/or for example according to various statistics (for example previously tested statistics about which aspects are most correlated with success and/or satisfaction, and/or for example data that take into consideration the additional contribution of each aspect after the previous aspects, such as for example from regression analysis). Another possible variation is to take into account for example also the variation or variance in the characterizations of each aspect across vocations, so that for example core aspects that are also more differentiated among vocations are more distinctive and can be used better for choosing than core aspects that are characterized very similarly across vocations, so they are preferably for example ordered higher within high-core-ness aspects. Another possible variation is to pre-order the aspects for example mainly according to variation or distinctiveness among the vocations, and/or by some other combination of this with core-ness scores and/or with the importances specified by the user and/or by previous users. Another possible variation is basing the core-ness scores also on the level of agreement between and/or within various sources when determining the characterization of the vocation on the aspects, which can be for example the agreement among a number of experts, and/or the agreement among various people who work in that vocation and/or for example the agreement between the experts and the people who work in the vocation and/or for example the agreement of the experts and/or the workers with various more objective statistical data, etc. So the core-ness score can be for example increased for the aspect in the vocation there is more agreement about it and thus the core-ness score can be for example increased to a value that represents also the level of agreement about it, or for example the core-ness score is derived directly from the data, and the level of agreement is registered separately, and then when sorting according to core-ness, for example aspects that have a similar core-ness score across vocations can be further sorted internally for example according to a sum or an average score for agreement on the core-ness rating for that aspect across the vocations. Another possible variation is to use this average importance data from previous users also for example at least partially in the formula for scoring the compatibility of each vocation on each aspect. Of course any of the described methods of pre-ordering the aspects can be similarly used also for the elimination process. Regarding the definition of importance, preferably it is explained to the user that the importance refers to “how important it is to get at least one of the marked options fulfilled in that aspect”. Of course, various combinations of the above and other variations can also be used. To the best of our knowledge, this has never been done before in the state-of-the-art computerized vocational guidance systems.

2. In the compensatory method, preferably the weight for scoring each aspect is based either on the user's specified weight, or on the core-ness of the aspect or on any combination of the above. (Preferably the user is allowed to use also absolute weight in the compensatory method. Another possible variation is to allow it only for more important aspects, which can be defined for example as aspects which are core aspects in a large number of vocations for example according to some threshold, and/or for example aspects which are known to be generally important for example from previous users and/or previous statistics). Also, the core-ness itself can be based for example on the number of vocations in which that aspect is a core aspect (and/or for example the sum of core-ness scores of each aspect across vocations if the core-ness code is not binary), or it can be applied for example to each tested vocation separately, so that the compatibility score for that aspect for that vocation is based on the core-ness of the aspect in that vocation, or some combination of these. The core aspects for each vocation can be determined for example by asking career-counseling experts and/or asking people who work in each vocation, and/or automatically, for example by determining that an aspect is a core aspect in a vocation if its characterization in the vocation is clearly tilted to one of the extremes (Preferably only the higher extreme, for example if its center of weights, or weighted mean, is at 4 or above on a 5-point scale). The core-ness rating of each aspect for each vocation can be for example binary, or a larger scale. This is like creating a reciprocal compatibility score that can take into account also the weights specified by the vocation. This is important since in the non-core aspects there can be for example more variations within the vocation. This has the further advantage that focusing on the core aspects can further reduce the effects of inaccuracies by the experts that characterize the vocations, since the chance that they will make mistakes in core aspects is lower than in non-core aspects. So for example, the scoring might give special weight to aspects which are both core aspects and considered to be important by the user, or use only for example core aspects for each vocation or for example use some weighted average, so that the final weight is for example the weight of the core-ness of the aspect twice more than the weight defined by the user or vice versa (of course many other ratios are also possible). Preferably the level of matching in each aspect in each vocation is either based on the overlap in the acceptable and optimal levels specified by the user and the levels characterized in the vocation, and/or on the gap in the centers of weights between the user's preferences and the vocation's characterization in each aspect, or for example a combination so that if there is overlap the user's own characterization is used for scoring, and if there is no overlap then for example the distance is used. Preferably the direction of the gap is also taken into consideration. The gap can be considered for example between the two nearest acceptable levels or for example between the two nearest optimal levels. This is explained more thoroughly in FIGS. 1a-f. Another possible variation is to take into account the core-ness of aspects in similar ways also when using other criteria instead of or in addition to user preferences, such as for example tested or reported user abilities, etc. Of course various additional combinations of the above and other variations can also be used. To the best of our knowledge, this has never been done before in the state-of-the-art computerized vocational guidance systems.

3. In the compensatory method, preferably the user is allowed to control for example the ratio between high importance to low importance, for example by letting him/her choose after the first aspect or after more aspects this ratio, preferably within a small range that is already known to be reasonable, such as for example between 2-6. (This way a ratio of 4 for example would mean that 1 highly important aspect that was not fulfilled can be compensated by 4 aspects of low importance that were fulfilled). (The relative weights of intermediate weights are preferably interpolated from the above extremes, but another possible variation is to ask about them or at least part of them also directly). Another possible variation is to use for example automatically a number of ratios, such as for example both 2,4 and 6, and for example display in the top list the top vocations that appeared at the top list with all the ratios or with most of the ratios (in this case, preferably larger lists are generated in the individual ratios, in order to generate from these lists the final list). Another possible variation is to lower at least somewhat the ratio given by the user since there is a tendency to overestimate the ratio and since lower ratios work well because of the robustness of the compensatory models. Another possible variation is to take into account for example average ratios (and/or also the direct values of at least some of the intermediary weights) generated from previous users and/or data about the correlation of various ratios with work satisfaction (and/or status and/or level and/or success and/or satisfaction from the employee) and/or to simply state it much more explicitly while the user is filling the weights so that he/she can take it into account. This is explained in more detail in the reference to FIGS. 1d-e. Of course various combinations of the above and other variations are also possible.

4. In the sequential elimination method, one of the possible variations is that the ranking is done, at least partially, like in one of the variations of feature 1 above, for example by choosing first the aspects which are core-aspects in the largest number of vocations, or some combination between this and the user's specified importances or ranking. For example, the user might be first given aspects which are core-aspects in the largest number of vocations and/or for example according to the largest sum of values, if the core-ness code is not binary (and/or that are most important to other people, for example according to the averages across all the previous users, and/or for example that are determined to be most important according to various statistics, as explained above) and asked to sort them and afterwards asked to sort aspects that are core-aspect in less vocations. Or for example at the beginning or at the end of the process the system might rely more or less on the core-ness of the aspects for ordering, for example depending on the number of remaining occupations. Or for example for core aspects the requirements for a match to avoid dropping a vocation from the list might be automatically more (or less) severe than with non-core aspects. (These rules, again, can be applied for example to general core-ness of aspects across vocations or to their being core-aspects in the given vocation, or some combination of the above). Another possible variation is to request from the user only ranking without specifying the importances themselves, and generating importances automatically according to this ranking, for example by first dividing the aspects into 2 or more groups, for example according to core-ness (or for example by asking the user to define first the most important group and then the next one, etc.), and requesting the user to rank-order aspects within each sub-group, and then for example aspects in the first group are translated to weights at a higher sub-scale of the weights, for example 6-7, and aspects in lower groups are translated to a lower sub-scale of the weights, for example 4-5, etc. However, this is less desirable if compensation is also used, since compensation depends much more on weights then on ranking, and getting the direct weights from the user is easier and more reliable. Of course various combinations of the above and other variations are also possible.

5. Another possible variation, both with sequential elimination and with compensation is to preferably allow the user to choose if he wants the scoring of vocations to be more or less severe (strict) and/or if he wants for example focused and/or small lists at the end, or more heterogenous and/or larger lists. In other words, if the user wants just a few very focused alternatives, he/she might request using harsher or stricter criteria for ruling out vocations (for example lower gap thresholds), as compared with a user who is interested in many different things and would like for example a more heterogenic group of results and/or a larger group of results, so that he/she can examine more possibilities. Such choices can be used for example when taking into consideration the gap in the centers of weights between the user's preference and the vocation's characterization in each aspect, so that for example to keep heterogeneity only more clear gaps are applied. Another possible variation is for example to allow the user himself to chose (for example in advance or during the process) the requested size (or a range of desired sizes) of the final list of vocations. Another possible variation is that for people who want more heterogeneity for example vocations are never dropped from the list if the aspect used in the current stage is not core for that vocation. Another possible variation is to use this as the default for everybody. Of course various combinations of the above and other variations are also possible.

6. Another possible variation, which can be used both in compensatory methods and in sequential elimination, is to allow the user to use also “OR's” and/or “IF's”. To the best of our knowledge, in the state-of-the-art computerized vocational guidance systems there are no provisions for logical relations between the various questions other than logical “AND”. In other words, although each question can preferably be given an importance level (or 0 importance) by the user, the default relation between each two questions is automatically only “AND”, so that the system by definition lowers the score for the potential vocation if it fulfills only some of the requested aspects of non-zero importance. This does not allow the user to define also alternate relations between the various aspects, such as for example “OR” relations or “IF” relations. So preferably the user is also allowed to define such relationships. For example, the user might agree to higher responsibility only if he/she is also given higher authority. Or the user might be interested in teaching but only if it is in technical areas. So “IF's can be marked or defined for example by letting the user graphically connect certain different variations of filling a certain question with certain options in another question, or for example allowing the user to define a set of “If then” sentences for example after finishing the normal filling of the questionnaire. Regarding “OR” relationships, for example the user might want any of a number of things with high importance but might want at least some of them to be fulfilled and not necessarily all of them. “OR” relationships can be marked or defined for example by allowing the user to encircle a group of questions together or for example mark them with a common mark or color, or for example by numerical definition of sets. This way the users can have much more flexibility in defining more complex relationships between various questions or sets of questions.

7. Another possible variation in to make a more integral combination between sequential elimination and compensation for example by starting with elimination, but adjusting the scores automatically to compensation (at least partially), for example if too few vocations are left after only a small part of the aspects has been used. Another possible variation is to allow the user preferably complete freedom to decide at each step of the sequential elimination (regardless of the number of remaining vocations and/or the remaining aspects) if he/she wants to continue with the sequential elimination or to transfer directly to compensation. Another possible variation is that preferably at any stage of the process the user can decide to translate everything between compensation and elimination, so that preferably the list of remaining vocations is updated to have been based on compensation from the start (thus becoming a list of top matching vocations) or vice versa (translated from compensation to elimination). In other words: an elimination list of remaining vocations can preferably be instantly transformed to have been based on compensation from the start (thus becoming a list of top matching vocations, which means that the list is changed into the list that would result if the process had been compensation from the start), and a list of compensatory top matching vocations can preferably be instantly transformed to the list that would result if the process had been based on elimination from the start. In this case, preferably the user can for example go back and forth in the steps of adding the aspects and view each previous stage as if it was made according to compensation or according to elimination, regardless of the way it was actually done before. Another possible variation is that at any stage after filling or changing an aspect the user can for example instantly view both the list based on elimination and the list based on compensation for example side by side, or for example some combined or integrated list, for example like the one shown in FIG. 2b. Preferably the user can choose if to apply compensation only for the remaining aspects that have not yet entered the process, or to apply it to all the aspects from the beginning. Similarly, preferably the user can be asked if to apply the compensation to all the vocations or only to those remaining after the elimination. Another possible variation is for example to enter into the elimination only aspects for which the user entered absolute importance, and after these aspects are finished automatically switch to compensation. Another possible variation is to use during the elimination process and/or during the compensation process different strictness for example depending on the core-ness of the aspects, so that for example aspects that are core in many vocations are used more strictly for elimination (and/or for determining the level of fitting in compensation), or for example specifically for each vocation the aspect may be used for eliminating the vocation (or significantly changing the score) only if it is a core aspect for that vocation. Another possible variation is for example to allow the users first to use a compensatory method, and for example experiment with eliminations afterwards. Of course various combinations of the above and other variations can also be used.

8. Another possible variation is to automatically analyze the user's answers during filling the questionnaire, in order to check the quality of his/her answers and preferably give the user feedback if the answers are not reasonable enough. This feedback can be given to the user for example during the filling process or after he/she has finished it or at least after various stages have been completed. This means for example confronting the user with non-trivial discrepancies between his rating of the importance of the aspects and his ranking of the aspects if both rating and ranking are used. In addition to this, the user's answers can be rated for example based on the optimal levels that he/she chooses, the acceptable levels on which he/she is willing to compromise, and the importance he/she gives to the aspect. So for example the user's choices can be defined as sufficiently discriminating or distinctive or differentiating if he/she has shown sufficient variation (for example in any of the above criteria—such as different levels of importance, various optimal levels or ranges, various acceptable levels or ranges or at least in some of them) among his answers about the various aspects, if he has shown sufficient resolution (for example if he used all the possible levels, for example of characterization and/or all the possible weights—preferably across the aspects), and/or used a sufficient range of levels (for example of characterization and/or of weights). Another possible variable is consistency—which checks for example if he/she used similar characterizations and/or weights for aspects which are known to be similar or highly correlated. For example if someone wants to work in a technological field of interest but does not want to deal with technical abilities, this could be a problem. Sometimes the above relation is only in one direction—for example it is OK to request verbal ability without interest in teaching, but teaching without verbal ability is problematic. Another possible variable is coherence, which means for example the correlation between importance and the range of acceptable levels and the position of the optimal level (or levels). For example, the more important an aspect is, the less reasonable it is to mark only levels in the middle without reaching one of the extreme options (one of the edges of the scale), although this might depend also on the specific content of the aspect. Also, if the user for example consistently uses high importance together with a wider range of acceptable levels than in low importance aspects it can be for example brought to his attention that this is not reasonable. Or the user can be warned for example if he/she gives too many aspects absolute or high weight or gives too many aspects weight 0. Another possible variation is that if there is a significant discrepancy between the weights chosen by the user and the actual core-ness of the aspects across vocations, the user can be warned or advised about this, again either for specific aspects during his filling them and/or for example in general across aspects. In such cases, and preferably depending on the case, the system can for example advise the user to correct specific unreasonable answers and/or to correct answers in general, and/or to consult with a human counselor about this and/or for example temporarily halt the dialogue until the user consults with the human counsellor. The above criteria can be defined more or less as quality of input. In addition to this for example the quality of the process may also be automatically analyzed, and for example the user is preferably warned for example if the user wants to use only a few of the options available in the program and/or wants to end the process too soon for example after filling just a small number of aspects and/or if he/she for example goes back and makes radical changes in importance or in characterization (for example reverses the direction of the scales or changes from very low weight to very high weight, etc) and/or for example if he/she uses various options at the end of the process in a non-logical order. Another possible variation is to give the user for example positive feedback if he/she does things correctly, such as for example if he/she checks the closeness of his answers to vocations that appeared in the elimination list but not in the compensation list (if both elimination and compensation were used), etc. Another possible criterion is for example automatically analyzing the quality of the output, so that for example if too many or two few vocations remain in the final list the user is advised about it, and preferably also the reasons for this are shown and preferably also recommendations of how to fix it most easily, which can be based also for example on an analysis of the distribution of patterns across the vocation, so that the minimal necessary correction can be shown. Another possible variation is to automatically analyze for example the level of homogeneity or heterogeneity of the resulting vocations and bring this to the user's attention, however in this case preferably the user is asked if it is OK with him/her, so that this is used more for bringing this into his awareness then for pushing to a specific change in his answers. Another possible variation is to use this for example in combination with the user's request to get a focused list or to consider many alternatives or more heterogenic results (as explained above in feature 5), and thus reflect to the user how close the results are to his request. Another possible variation is to ask the user for example in advance and/or after the results are displayed what vocational alternatives he/she is already considering, and then automatically analyze and preferably report to the user for example how similar the resulting vocations are to the alternatives the user mentioned, and/or how many of them are included in the list and/or why those that do not appear in the final list did not enter it and/or for example, in case of compensation, the serial position in terms of compatibility each of them has compared to the other vocations (for example place 52 out of 400 vocations). Of course various combinations of the above and other variations are also possible.

9. Another possible variation, which can be used both with compensation and with elimination, is for example to automatically also give to the person preferably at the end of the list of most compatible occupations also a list of occupations that were dropped out because of just one aspect. In sequential elimination this can be any aspect that was used at the elimination, and preferably only if there was a slight discrepancy in that item. In compensation it can be for example any aspect in which absolute weight was used, and preferably the vocations shown are those that would have a higher score than those on the normal list if the options in that aspect are a little extended or the weight reduced from Absolute. Another possible variation, which can also be used both in compensation and in elimination is to automatically analyze for example which aspects have caused most of the lowering of scores (or for example most of the dropping out of vocations, in elimination), and for example display to the user these aspects in descending order of how much they affected the process.

10. Another possible variation is to allow the user to request a list of similar vocations for example to the vocations that he/she received in the final list (or to any other vocation that he/she desires), and preferably allowing the user to chose if to base the similarity on the core aspects of the vocations or on his own rating of importances or some combination of the above, and/or for example if to base the similarity only on the aspects that entered the elimination process (if elimination was used) or on all the aspects and/or for example on all the aspects for which the user gave importance above 0 (with or without taking into account also the importance itself) and/or for example all the aspects for which the user gave weight above 0, which are also core aspects. An example of this is shown in FIG. 3.

11. Another possible variation is to allow the user to get for each vocation that he/she desires a detailed analysis of how close the vocation is to the desired aspects, for example by showing graphically for each aspect the gap between the levels the user marked as acceptable and optimal and the characterization of the vocation, and/or a statistical indication or an analysis of which aspects most contributed to or reduced the fit with that vocation, and/or what is the ordinal score of the requested vocation compared to other vocations in terms of fitting the user's requirements (for example, there are 23 vocations with the same or higher scores). An example of this is shown in FIG. 4. Another possible variation is to allow the user to request similarly a detailed analysis that compares the profiles of two or more vocations to each other, which similarly can be shown for example graphically and/or statistically.

12. Another possible variation is to allow the user to specify more than 2 levels of acceptability, for example 3 levels (For example: optimal, desirable and acceptable), or any other number of levels, which can be for example verbally defined as above and/or numerically defined. This can increase the flexibility and allow a better approximation to the real curve.

13. Another possible variation is to show the user for example Video clips illustrating at least some of the aspects where needed (preferably for example before the user is requested to rank the aspect and/or to define its importance and/or to fill his preferences for that aspect), and/or for example video clips illustrating the profiles of various vocations and/or for example their core-aspects—for example automatically for the final list of vocations, and/or specifically for vocations or aspects requested by the user.

14. Preferably the system is implemented online, for example on the Internet, so that users can access it directly, preferably through a web browser. The processing can be for example mainly on the site, for example by accessing a program and a database on the site after the user fills each aspect, or for example most of the processing is done on the user's own computer for example by downloading and installing some executable program, or more preferably for example by using an executable code that can be run by the browser itself, such as for example Java and/or Javascript and/or active-X. This has the advantage that a faster response time can be achieved after each action of the user. If the main processing is done on the user's computer then preferably the database of vocations and their characterizations is also loaded together with the executable code, normally or with some encryption that can help prevent copying the database itself by users. Another possible variation is to have, in addition or instead, a version that is run on computers for example from a CD or a DVD, which can have for example extended features such as for example more graphic or video, etc.

Of course, various combinations of the above and other variations are also possible (both within the clauses and among options in separate clauses). Of course, the above features can be used also independently of each other, and at least some of them can be used also in non-hybrid systems. Also, although the systems and methods of the present invention have been described in relation to vocational and/or career choice, in which the user is helped to choose a vocation or career (or field of study), another possible variation is that at least some of these features can be used also for example for matching users with specific job offerings, although there are some differences, such as for example a dynamic database on the other side that changes all the time, instead of a more static database of vocations (which typically might be updated once in a while only if vocations are added or removed or some characterizations updated). Another difference is that in this case typically the user knows already which vocation he/she wants and typically is also already trained or experienced in that area, and also preferably more specific requirements from the side of the job offerer are also included and taken into consideration and/or for example at least some of the aspects can be different. Another possible variation is that in addition to this, these and/or similar features and principles can be used also for other areas where there are multiple aspects and multiple available choices, such as for example choosing a university or college, buying or renting a car, buying or renting an apartment or house, etc. (Similarly, at least some of these features can be used also for example for dating, however these features in regard to computer dating are covered by other applications by one of the present inventors). And in these areas also, it can be used for example for helping users decide what types of apartments or types of cars are good for them in general, without matching it for example with a specific apartment or car offering, while preferably using a more static type of database like in the vocational guidance choice (for example helping the user realize that his preferences will be more suited by an apartment in the suburbs with a garden), or, preferably in a different embodiment, (with at least some of the present features) for matching the user for example with specific apartment or car offerings. To the best of our knowledge the first of these two variations—helping users decide for example which type of apartment or car are most fit for them in general—has never been done in any way, i.e., no such guidance systems exists whatsoever, so even the very idea of designing such a guidance system is new. However, in these two examples, unlike vocational choice, there is no training or study involved, so another possible variation is for example to combine the two kinds of guidance systems, so that for example the user can first be guided to decide better for example what type or types of apartment or type or types of car in general will best suit his/her needs, and afterwards preferably for example immediately matched also with a database of for example specific car or apartment offerings. In this case the same profile of aspects filled by the user can be used for example also for the second stage of matching with specific offerings, or for example the user might be asked to fill some additional aspects which are used for this, preferably together with the first aspects (filled for the general type matching) or at least with part of them. Of course another possible variation for example with apartments and/or cars is to use just one stage wherein all the relevant criteria are entered directly as aspects and the targets are directly specific apartments or specific car offerings, even if the aspects include for example various levels of categorization or generalization. Another possible variation regarding vocations is for example to match the user with general types or groups of vocations that are similar, instead of or in addition to specific vocations, for example engineering in general, enterpreneurship, humanities, etc., for example in stages or at the same time.

Definitions and Clarification

Throughout the patent whenever variations or various solutions are mentioned, it is also possible to use various combinations of these variations or of elements in them, and when combinations are used, it is also possible to use at least some elements in them separately or in other combinations. These variations can be in different embodiments, and/or in different versions of the software, and/or sometimes different options available to choose from. In other words: certain features of the invention, which are described in the context of separate embodiments, may also be provided in combination in a single embodiment. Conversely, various features of the invention, which are described in the context of a single embodiment, may also be provided separately or in any suitable sub-combination. Although the systems and methods have been described in relation to vocational and/or career choice (which can include of course for example also choosing a major for studies, etc.), these and/or similar features and principles and/or at least some of them can be used also for other areas where there are multiple aspects and multiple available choices, such as for example choosing a university, buying or renting a car, buying or renting an apartment, etc. So throughout the entire text of the patent, including the claims, whenever vocations and/or career are mentioned it can be also cars or apartments or other multiple choice targets (potential choices) with multiple aspects.

As used throughout the entire specifications and the claims, the following words have the indicated meanings:

“User” or “users” as used throughout the patent, including the claims, can interchangeably be either user or users, and can refer to both sexes even when words such as “he” or “she” or “his” or “her” are used.

“Aspects” are the desired attributes of the vocation or career—each question in the questionnaire that the user fills typically represents one aspect.

“Importance” or “Weight” or “Rating” usually means the independent level of importance the user gives each aspect. However, depending on the context, “weight” is also used in the context of the actual weight given to each importance for the actual matching score formula, and also in the context of the relative weight given to the user's importances, in relation to the weight given to the core-ness score according to the vocation. The importance scale can have for example 2 levels (e.g. Important/not important), but is preferably larger and can be defined for example verbally and/or numerically.

“Absolute weight” or “Absolute importance” or “Necessary” means that the user considers a certain aspect to be uncompromiseable, so that if it is not fulfilled, no amount of other fulfilled aspects can compensate for it.

“Ranking” means the way the user sorts (orders) the aspects according to a preferably descending order of their relative importance.

“Core aspects” means aspects which are considered (preferably by experts or by people closely familiar with the vocation or directly involved in it, or according to statistics) highly relevant to a certain vocation or one of its inherent characteristics or its essence or crucial aspects. Some vocations can have few or no core aspects (for example Guidance Counselor) and others can have much more (for example Industrial Engineer can have more than a dozen core aspects).

Levels or options refers to the available options to chose from in each aspect, for example 5 levels of responsibility, from Low to High. These options or levels can be for example on a non-ordinal scale (for example describing just various options in no particular order, depending on the nature of the aspect), or on an ordinal and preferably also linear sequence. For example in vocational choice, typically these levels are sequential and linear, like in the above example of responsibility. Within each such option or level there can be 1 or more levels that are available as possible values, for example 0/1, 0 or 1 or 2, or more possible values, and these values can be for example defined numerically and/or verbally.

Optimal level or levels means one or more options within an aspect, which the user wants at a high level of desirability.

Acceptable level means one or more options within an aspect, which are less desirable to the user, but he/she is willing to compromise about them.

Characterization of a vocation means defining (preferably by experts or by people closely familiar with the vocation or directly involved in it) the degree by which each option in each aspect fits the vocation. This can be for example either on a binary scale, or on a larger scale (For example: 2=Most characteristic, 1=less characteristic, 0=not characteristic).

Characterization or filling of an aspect by the user means that the user defines the acceptable and optimal levels in the aspect. The optimal can be limited to one option, or more preferably unlimited, so that more than one option can be defined as optimal.

Center of weighs (or weighted mean) is similar to finding the balance point of a lever. It is a weighted average that finds the central weight according to the level marked at each option of the aspect and its distance from the center. Preferably this is computed for example by the average of all the positions of the options relative to the low end of the scale multiplied by the numerical value given to that option, so for example if there are 5 available levels in the aspect, the pattern Low 00122 High becomes (0*1+0*2+1*3+2*4+2*5)/5, which gives a center of weights of 4.2 on a scale of 5.

### BRIEF DESCRIPTION OF THE DRAWINGS

FIGS. 1a & b show an example of a preferable characterization of 2 vocations on a group of aspects, including an indication of the core-ness of each aspect for that vocation.

FIG. 1c shows a few examples of possible matches or mismatches between the user's desired profile on a certain aspect and the vocational characterization, and various possible preferable implications, including for example depending on requested strictness.

FIGS. 1d-e shows examples of preferable scales of weights and possible ratios among them.

FIG. 1f shows a few examples of preferable variations of the weight given to the user's importances in comparison to the core-ness.

FIGS. 2a-b shows 2 examples of preferable resulting lists of most fit potential vocations.

FIG. 3 shows an example of a preferable list of similar vocations to a requested vocation.

FIG. 4 shows a few examples of a preferable detailed analysis of how close a vocation is to the desired aspects.

### DETAILED DESCRIPTION OF THE PREFERRED EMBODIMENTS

All of descriptions in this and other sections (including in the summary) are intended to be illustrative examples and not limiting. The system and method described may be also regarded as a virtual machine that performs the described functions.

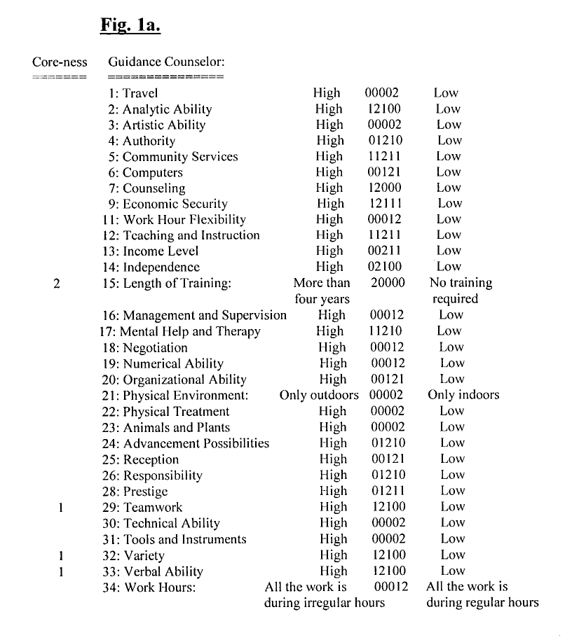

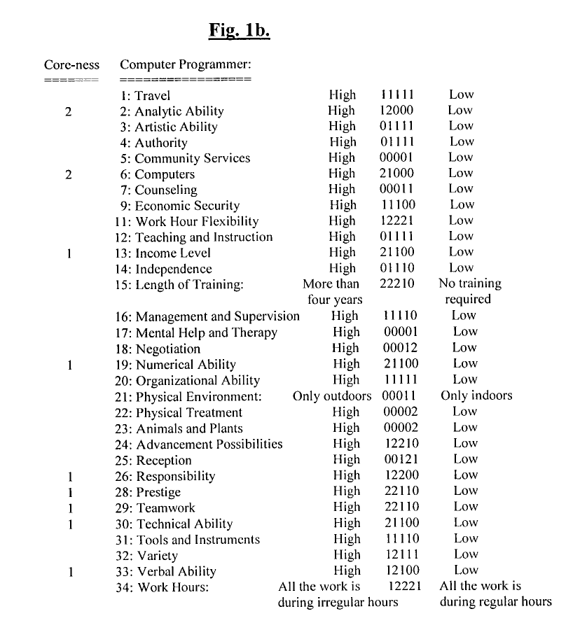

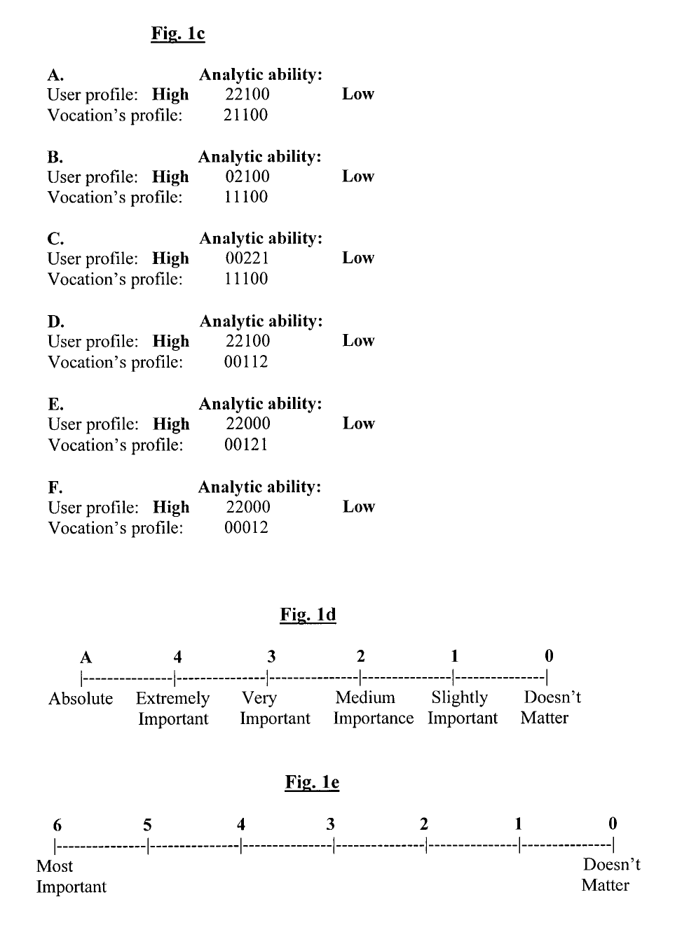

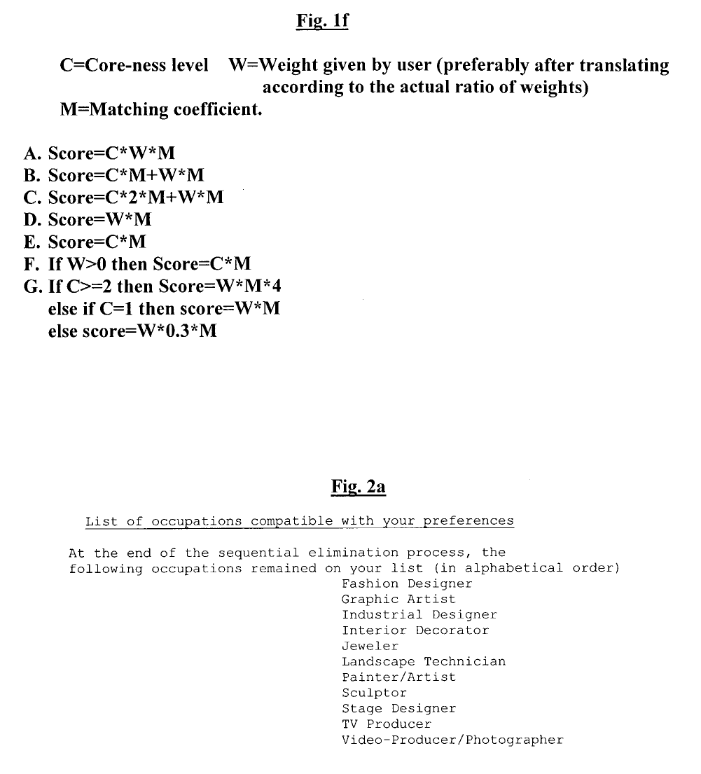

Referring to FIGS. 1a & b, we show an example of the characterization of 2 vocations on a group of aspects, including an indication of the core-ness of each aspect for that vocation. In this example for simplicity each aspect for which no core-ness code is marked is considered automatically non-core (0 core-ness). In this example 31 aspects are used (numbered until 34 for technical reasons, and for example with 5 levels or options each), and there are for example 3 levels of characterizing each aspect on each option (0,1 or 2) and similarly for example 3 levels of core-ness: 0 represents non-core aspects, 1—partially core, and 2—highly core. As can be seen, for example Guidance Counselor has one high-core aspect and 3 partially core aspects. On the Other hand, computer-programmer in this example has 2 highly-core aspects and 7 partially-core aspects. Of course, this is just an example and other numbers (for example of aspects, options and/or possible values for each option) and/or contents can be used.

Referring to FIG. 1c, we show a few examples of possible matches or mismatches between the user's desired profile on a certain aspect and the vocational characterization, and various possible preferable implications, including for example depending on requested strictness. This example refers for example to Analytic ability, but it can be similarly applied to any other aspect. In sequential elimination the vocation will typically be dropped from the user's list only in examples E & F, however for example if higher strictness was requested, the vocation might also be dropped for example in case D, since although there is one common level, the user's profile and the vocation are clearly in opposite tendency on this aspect. On the other hand, if for example more leniency was requested, the vocation might not be dropped for example in case E, since there is only a gap of 1 level, or for example it might not be dropped at all if this is not a core aspect for the specific vocation. When compensation is used, clearly case A gets the highest score, next comes case B, and the other cases get lower score or a 0 score on this aspect, depending for example if the system requires at least one matching level or gives at least some score even if there is no such level as long as the gap is not too large. Of course, various formulas can be used, including for example the gap between the centers of weights (Preferably computed for example by the average of all the positions of the options relative to the low end of the scale multiplied by the numerical value given to that option, so for example the pattern High 22100 Low becomes (0*1+0*2+1*3+2*4+2*5)/5 which gives a center of weights of 4.2 on a scale of 5), and preferably higher score when the user gets a match on a level marked for example by 2 instead of 1. On the other hand, some specific qualities of individual aspects are preferably also taken into consideration, since for example in aspects such as status and salary more than the user asked for is never really bad for the user, so preferably the system always automatically corrects the user's answers upwards in such aspects and/or automatically corrects the characterizations of the vocations to reflect this in cases where they don't. Another possible variation is to take into account also the number of overlapping levels that exist (which is for example the highest—3—in case A). However, if such a measure is also counted, preferably it has only a relatively low contribution to the matching score, since for example if the user can get one of the levels he requested with higher preference he will probably be almost as happy about it as when he gets two. Another possible variation is to use similar methods to take into account also matches in other things instead of or in addition to user preferences, such as for example tested or reported user abilities, etc. Another possible variation is for example to ignore the gap and check only if there is an overlap in at least one position. Of course, various combinations of the above and other variations are also possible.

Referring to FIGS. 1d-e, we show two examples of a preferable scale of weights and possible ratios among them. In the example shown in FIG. 1d “Absolute importance” is marked by a letter instead of a number, in order to emphasize the non-linearity between it and the weight next to it. So “Extremely important” can be given for example a weight 10 times higher than “Slightly Important”, and then “Very important” for example might be given a weight 5 times more than “Slightly Important”, and “Medium Importance” can be for example given a weight of 3 times “Slightly Important”. On the other hand, for example lower ratios may also be used and may be more preferable, and especially so if the scale has only numbers, as shown for example in FIG. 1e, (or for example all numbers except for the one labeled “Absolute”), since on a non-labeled scale users are more likely to interpret the numbers as representing a more linear scale. In the compensatory method, preferably the user is allowed to control for example the ratio between high importance to low importance, for example by letting him/her choose after the first aspect or after more aspects this ratio, preferably within a small range that is already known to be reasonable, such as for example between 2-6. (This way a ratio of 4 for example would mean that 1 highly important aspect that was not fulfilled can be compensated by 4 aspects of low importance that were fulfilled). (The relative weight of intermediate weights are preferably interpolated from the above extremes and/or for example the user is asked directly about at least some of them). Another possible variation is to use for example automatically a number of ratios, such as for example both 2,4 and 6, and for example display in the top list the top vocations that appeared at the top list with all the ratios or with most of them (In this case, preferably larger lists are generated in the individual ratios, in order to generate from these lists the final list). Another possible variation is to lower at least somewhat the ratio given by the user since there is a tendency to overestimate the ratio and since lower ratios work well because of the robustness of the compensatory models. Another possible variation is to use for example the average ratios defined by all the previous users. Another possible variation is for example to correlate the results of previous users and/or of people who work in various vocations who fill the questionnaire with job satisfaction and/or status and/or level and/or success and/or satisfaction from the employee, and then for example use the questionnaires already filled by the users and or workers and automatically check which ratios generate scores which are with the highest correlation with the above variables (and then to use for example the ratio that turned out most successful). Another possible variation is to also ask the users the ratio, and use this for later checking the relation between the ratio stated or desired by the user and the ratio most predictive as described above. Another possible variation is to check statistically various relationships between the ratio and various characteristics of the distribution of weights used by each user, so that for example the ratio can be automatically generated for each user by taking into account also the structure of the weights used by the user. Another possible variation is to take into account also the number of aspects, since if there are for example a 100 aspects there is much more chance for compensation by less important aspects than if there are for example 30 aspects, so when there are more aspects the ratio between weights can be larger. Another possible variation is to use for example a numerical scale, and explain to the user that these numbers are on a linear scale and are used literally as is, so that the user can take this into account while choosing the weight for each aspect. In other words, for example an importance level labeled “6” is 6 times more important than an importance level labeled “1” and 2 times more important than an importance level labeled “3” (preferably except for absolute weight, which is always non-linearly translated, so preferably absolute weight is left verbally labeled, without a number). Another possible variation is to use verbal labels for example like in FIG. 1d but to add near each label also the actual number assigned to it according to the ratio, so that the user can also take that into account. Another possible variation is that in the above case the scale is preferably shown with distances representing the actual distances between the labeled points. Another possible variation is to use also intermediate numerically labeled marks between verbally labeled points where needed, so that for example if “Very Important” is more than one step away from “medium Importance”, one or more numerically labeled marks are added between them and preferably explain to the user that this represents the actual relations between the weights. Of course these are just examples and the scale can be also much larger, for example based on values between 0 to 100, etc. Of course various combinations of the above and other variations are also possible

Referring to FIG. 1f, we show a few examples of preferable variations of the weight given to the user's importances in comparison to the core-ness. Preferably the W (weight given by user) used is after the processing, such as for example any of the variations shown in the reference to FIGS. 1d-e regarding the ratios between the weights, since the Weights' codes do not necessarily translate linearly to a ratio of weights with the same numerical values. Similarly the Core-ness code can be for example literal or also require some translation to relative factors or ratios. As can be seen from the examples given, in case A the score for that aspect for the vocation is increased only if the aspect is both important (at least above 0 importance) in the eyes of the user and has at least some core-ness. In case B the score is composed of the same weight to the user's importance and to the core-ness of the aspect in that vocation. Case C is a weighted average that gives for example double weight to the core-ness as compared to the importance assigned by the user. Case D is an example of ignoring the core-ness and using only the user's weight. Case E is the opposite extreme case of ignoring the user's weight and using only the core-ness. Case F is an example of using only the core-ness, but only if the user's importance is non-0. More general formulas would be for example Score=(x*C+y*W)*M and Score=x*C*W*M, which cover all the possibilities from A to F, by giving x or y a real value of any desired magnitude, or 0 value. Case G is an example of even more complex non-linear conditions. As explained in the summary, for example the core-ness of the aspect across the vocations can also be entered into the formula. Another possible variation is for example in the compensation to display separately a list in which the matching is based more on the user's importances and a list based more on the core-ness of aspects (preferably per vocation), or a combined list which shows for example only the vocations that appeared on the top of both lists, or for example a list in which the vocations that appear also on the other type of list are highlighted, etc. The score across aspects is preferably the sum of the scores for the aspects that have been taken into consideration, and is preferably normalized to percentages out of the theoretical maximal score that is possible over those aspects. Of course these are just a few examples and many additional variations or combinations are also possible.

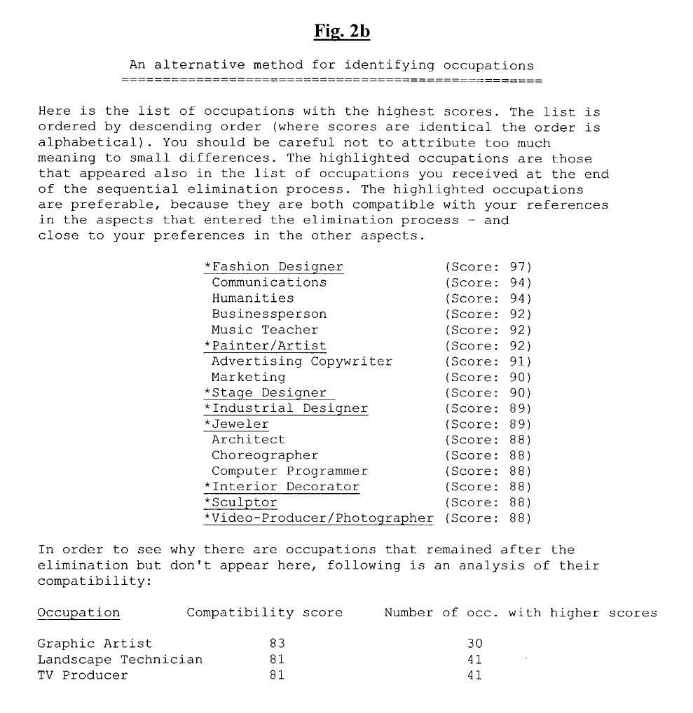

Referring to FIGS. 2a-b, we show 2 examples of preferable resulting lists of most fit potential vocations. As shown in FIG. 2a, in the elimination list the order is preferably an ascending alphabetic order, however another possible variation is to sort them automatically by taking into account also for example the more precise compatibility matches according to the aspects that entered the process (For example according to any of the methods described in the references to FIGS. 1c-f). Another possible variation is to allow the user for example to get them internally sorted by filling the additional aspects and using compensation. Another possible variation is to sort them for example randomly, or according to any other desired criterion such as for example the matching according to any specific aspect desired by the user or for example the percent of women in each vocation (for example if the user is a female). Preferably the user can choose from any of these options. The results of the compatibility process are preferably in descending order of compatibility, as shown in FIG. 2b, and if a hybrid system is used, preferably vocations that appeared also in the results of the elimination process are highlighted. Preferably the user can for example press a key each time to see additional results in descending order. Another possible variation is to allow the user to chose any other order within the top list for example like in the options described above for the elimination resulting list (For example the user might even be allowed to request the order to be alphabetical, for example within the group of highest 20 matches, but that is less desirable when compensation results are shown), but preferably still with the matching score next to each vocation. Another possible variation is for example to keep the order sorted by compatibility but add information such as for example the percent of women in each vocation near each vocation without changing their order. Of course, various combinations of the above and other variations can also be used.

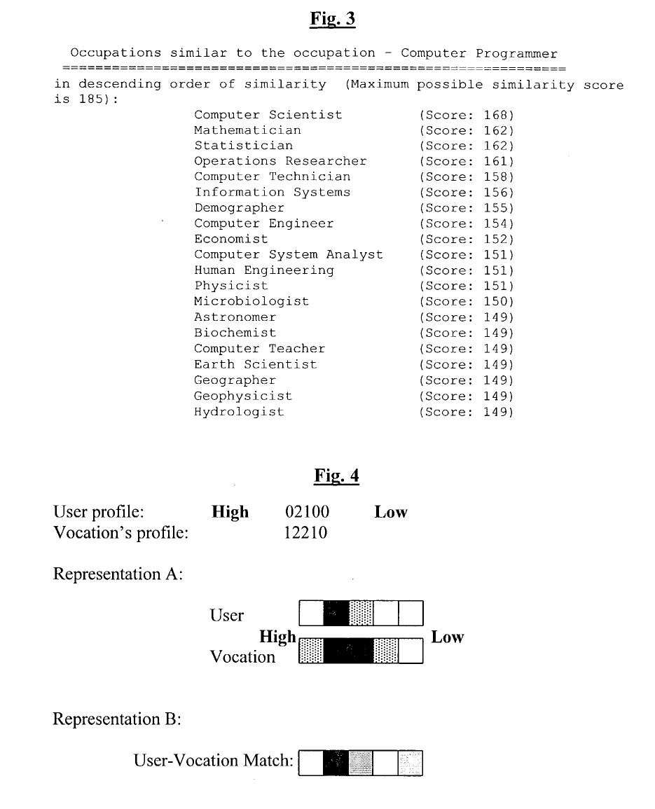

Referring to FIG. 3, we show an example of a preferable list of similar vocations to any vocation that the user requests. Preferably the list is in descending order of compatibility, and preferably the user can choose for example if to base the similarity analysis on the core aspects of the vocations or on his own rating of importances or some combination of the above (or for example equally on all the aspects), and/or for example if to base the similarity analysis only on the aspects that entered the elimination process (If elimination was also used) or on all the aspects. The similarity matching itself can be for example based on centers of weights and/or on matching methods similar to those described in the reference to FIG. 1c, and/or for example take into account the core-ness of the aspects. For example, for each aspect compared, the comparison can give a different matching score, in addition or instead, also at least partially according to whether the aspect is core in both of the vocations being compared, or core only in one of them, or non-core in both of them, or for example highly core in one of them or partially core in the other. Another possible variation is to take in account for example the similarity between the number of core aspects and/or partially core aspects each vocation has. Another possible variation is simply comparing how many common core aspects and/or common partially core aspects the two vocations have, since if we define core-ness based mainly for example on the tendency of the center of weight to be near the high end if the scale, then a match in which aspects are core implies also a similarity in their characterization on these aspects. Of course another possible variation is for example to normalize the scores to percentages up to 100%, like in the compatibility scores of the compensation. Another possible variation is to order them for example alphabetically but show the similarity score near each vocation, or for example in the other direction—order them according to similarity but not show the similarity scores themselves. Of course, various combinations of the above and other variations are also possible.

Referring to FIG. 4, we show a few examples of a preferable detailed analysis of how close a given vocation is to the desired aspects, for example by showing graphically for each aspect the gap between the levels the user marked as acceptable and optimal and the characterization of the vocation. This mapping of aspects can be for example sorted alphabetically and/or for example by the order in which the user filled them and/or for example in descending order so that the most matching aspects are at the top and/or for example in descending order so that the aspects that had the most effect (for example positive and/or negative) on the match are shown first, and/or for example according to core-ness so that the aspects that are most core for that vocation are shown first and/or for example according to the importances of the aspects as defined by the user and/or by average user and/or by other statistics. For each aspect shown, the relation between the user's requested profile and the vocation's characterization on that aspect can be shown for example in two lines, one below the other, preferably with the same color code, so that for example if the 2 patterns are:

| | | | |
|---|---|---|---|
| User profile: | High | 02100 | Low |
| Vocation's profile: | | 12210 | |

as shown in FIG. 4, the levels marked by 2 can be for example marked in each line by a stronger color and/or higher peak and/or other more conspicuous mark, levels marked by 1 can be for example marked by a less strong color and/or lower peak and/or other less conspicuous mark, and levels marked by 0—still less strong color and/or lower peak and/or smaller mark, etc. (Representation A). Another possible variation is use for example only a single line for each aspect and show by the color and/or the marks the points of convergence, so that for example an option where both the user and the vocation have a “2” will be marked most conspicuously (for example in strongest colors and/or highest peak), an option where one of them has a “1” and the other a “2” will be marked a little less conspicuously, an option where one has “1” and the other “0” will be marked less conspicuously, and a case of 2 against 0 or 0 against 2 will be marked for example by the weakest color. Cases of 0 against 0 can be for example marked with a middle color or kept for example without color (Representation B). Of course, this is just an example and many other marking schemes can be used, and for example more or less than 5 options may exist and smaller or larger ranges or sets of numbers per option can be used (instead of 0,1 or 2). For example, special colors can be chosen to have special meanings, for example Green for fitting and Red for not fitting, etc. Many other combinations of the above and other variations are also possible. The core-ness of the aspect can be shown for example by the general height of the marks, and/or for example the aspects can be grouped into sub-lists according to their core-ness level. Another possible variation is to show for example a statistical indication of which aspects most contributed to or reduced the fit with that vocation, and/or the compatibility score with any desired vocation and/or for example what is the ordinal score of the requested vocation compared to other vocations in terms of fitting the user's requirements (for example, there are 23 vocations with the same or higher scores).

While the invention has been described with respect to a limited number of embodiments, it will be appreciated that many variations, modifications, expansions and other applications of the invention may be made which are included within the scope of the present invention, as would be obvious to those skilled in the art.

We claim:

1. A computerized choice guidance system wherein the choices are about at least one of careers/vocation, apartments, cars, and other multiple choice targets with multiple aspects, except for computer-dating, comprising at least one of:
a. A system for giving the user immediate feedback about the results of his choices at intermediary stages even when using a compensatory method.
b. A system wherein the core-ness of the aspects for the potential choice targets is also taken into consideration.
c. A system wherein the user can also define at least one of “OR” and “If” relationships among aspects.

2. The system of claim 1 wherein this immediate feedback is accomplished by letting the user view after at least one of {filling each aspect, filling a group of aspects, making changes in aspects, and changing their importance}, the resulting list of most compatible choice targets according to the aspects already filled by him.

3. The system of claim 1 wherein in order to get more meaningful results from the start the aspects are also ordered in advance, at least partially, by at least one of: Descending order of importance, descending order of core-ness, and other criteria.

4. The system of claim 3 wherein this pre-ordering is done by at least one of:
a. Asking the user to specify the importance in advance at least for the more important aspects in his eyes.
b. If the user is only asked to define the importances, the ranking is generated automatically from the importances as defined by the user and/or by taking into account also known importances from previous statistics and/or previous users, at least for internal sorting among aspects to which the user gave the same importance.
c. Asking the user to rank in advance the aspects, like in the sequential elimination, except that at each step compensatory rules are used instead of elimination, except for aspects where the user marked absolute importance.
d. Automatically ordering the aspects in advance according to their already known importances.
e. Automatically ordering aspects according to at least one of known correlations with success and/or with satisfaction and/or additional contribution of each aspect after the previous aspects, and/or other statistics.
f. Automatic ordering of the aspects by using core-ness data, so that aspects are pre-ordered in descending order of core-ness, so that each aspect is positioned according to at least one of: the number of choice targets in which it is a core aspect, and its sum of core-ness across choice targets.
g. The variation in the characterizations of each aspect across choice targets is taken into account when automatically ordering aspects, so that aspects that have a more distinctive value appear before aspects with less distinctive value.
h. High core-ness aspects that are also more differentiated among choice targets and are therefore more distinctive are ordered before high core-ness aspects that are less distinctive.

5. The system of claim 1 wherein at least one of the following features exist regarding the core-ness:
a. The core-ness of aspects across choice targets is used for aiding at least partially in the ordering process of aspects for sequential elimination.
b. The core-ness of aspects across choice targets is used at least as part of the weight formula for scoring the level of matching of each choice target to at least one of the user's preferences and any other relevant matching criteria.
c. The core-ness of aspects within each choice target is used at least as part of the weight formula for scoring the level of matching of that choice target to at least one of the user's preferences and any other relevant matching criteria.
d. Only the core-ness is used instead of the user specified importances.
e. A combination of core-ness and user importances is used.
f. The core-ness of aspects across choice targets is used at least partially for changing the strictness level of the matching requirements in each aspect.
g. The core-ness of aspects within each choice target is used at least partially for changing the strictness level of the matching requirements in each aspect.
h. The user is allowed to use absolute weights only in aspects which have high core-ness across choice targets.
i. The core aspects for each choice target are determined by at least one of asking career-counseling experts, asking people who work in each choice target, and various statistics.
j. The core aspects for each choice target are determined automatically.
k. The core aspects for each choice target are determined automatically, based on aspects with centers of weights near the positive extreme of the scale.
l. The core-ness rating of each aspect for each choice target is at least one of binary and a larger scale.
m. The core-ness score of an aspect across choice targets is computed as the number of choice targets in which the aspect is considered a core aspect.
n. The core-ness scores and/or the sorting according to core-ness take into consideration at least partially also the level of agreement between and/or within various sources when determining the characterization of the choice target on the aspects, wherein said sources are at least one of experts, people who work in the choice target, and various statistics.
o. The core-ness score of an aspect across choice targets is computed as the sum of core-ness scores of the aspect across choice targets.

6. The system of claim 1 wherein the level of matching in each aspect in each choice target is based on at least one of:
a. The overlap in acceptable and optimal levels.
b. The size of and/or directions of the gap in at least one of the centers of weights and the borders between the user's preferences and the choice target's characterization in each aspect.
c. The number of matching options in each aspect.

7. The system of claim 1 wherein at least one of the following features exist:
a. In the compensatory method the user is allowed to control the ratio between high importance to low importance and/or to define this also for at least some of the intermediary values.
b. In the compensatory method automatically a number of different ratios between high importance to low importance is used and in the top list are displayed choice targets that appeared at the top list across the different ratios.
c. The user is allowed to choose if he/she wants the scoring of choice targets to be more or less strict.
d. The user can choose if he/she wants at least one of more focused or small lists at the end, or more heterogenous or larger lists.
e. The user can choose the requested size of the final list of choice targets, at least one of: In advance and During the process.
f. When using compensation the list size of most compatible choice target can be limited by at least one of a minimum and a maximum value, and the exact size is determined according to some absolute and/or relative criteria of score level.
g. The user can specify more than 2 levels of acceptability.

8. The system of claim 7 wherein choices of desired strictness and/or desired heterogeny can be used when taking into consideration the gap in the centers of weights between the user's preference and the choice target's characterization in each aspect.

9. The system of claim 1 wherein “OR” relationships between aspects can be defined by at least one of:
a. Marking a group of questions together with a common mark.
b. Numerically defining sets.

10. The system of claim 1 wherein “IF” relationships between aspects can be defined by at least one of:
a. Letting the user graphically connect certain different variations of filling a certain question with certain options in another question.
b. Allowing the user to define sets of “If then” sentences.

11. The system of claim 1 wherein there is a more integral combination between sequential elimination and compensation, by at least one of:
a. Starting with elimination, but adjusting the scores automatically to compensation at least partially, if too few choice targets are left after only a small part of the aspects has been used.
b. Allowing the user freedom to decide at each step of the sequential elimination (regardless of the number of remaining choice targets) if he/she wants to continue with the sequential elimination or to transfer directly to compensation.
c. Letting the user choose if to apply compensation only for the remaining aspects that have not yet entered the process, or to apply it to all the aspects from the beginning.
d. Letting the user choose if to apply the compensation to all the choice targets or only to those remaining after the elimination.
e. Entering into the elimination only aspects for which the user entered absolute importance, and after these aspects are finished automatically switching to compensation
f. Allowing the user at any stage of the process to decide to translate everything between compensation and elimination, so that the list of remaining choice targets is updated to have been based on compensation from the start or to have been based on elimination from the start.

12. The system of claim 1 wherein the user's answers are automatically analyzed during filling the questionnaire, in order to check the quality of his/her answers.

13. The system of claim 12 wherein at least one of the following features exist:
a. The user is given feedback if the answers are not reasonable enough, at least one of: During the filling process, After he/she has finished it, and at least after various stages have been completed.
b. The user is confronted with non-trivial discrepancies between his rating of the importance of the aspects and his ranking of the aspects if both rating and ranking are used.
c. At least one of the user's differentiation, consistency, and coherence can be automatically analyzed.
d. The user can be warned if he/she gives too many aspects absolute or high weight or gives too many aspects weight 0.
e. If there is a significant discrepancy between the weights chosen by the users and the actual core-ness of the aspects, the user can be advised about this.
f. Feedback for such automatic analysis is given to the user at least one of: During his filling them and In general across aspects.

14. The system of claim 1 wherein the quality of the process may also be automatically analyzed.

15. The system of claim 14 wherein if the user wants to use only a few of the options or end the process too soon he is advised about it.

16. The system of claim 1 wherein the quality of the output is automatically analyzed.

17. The system of claim 16 wherein the level of homogeneity or heterogeneity of the resulting choice targets is automatically analyzed and brought to the user's attention.

18. The system of claim 1 wherein automatically the user is also given a list of occupations that were dropped out because of just one aspect.

19. The system of claim 18 wherein in compensation that aspect can be any aspect in which absolute weight was used.

20. The system of claim 1 wherein it is automatically analyzed which aspects have caused at least one of most of the lowering of scores or dropping out of choice targets, and these aspects are displayed to the user in descending order of how much they affected the process.

21. The system of claim 1 wherein the user is allowed to get for any choice target an analysis of at least one of:
a. Which aspects most affected the fit with that choice target.
b. What is the ordinal score of the requested choice target compared to other choice targets in terms of fitting the user's requirements.
c. A list of similar choice targets to any choice target and to chose if to base the similarity on at least one of the core aspects of each choice target or on his own rating of importances or core-ness of aspects across choice targets or any combination of the above
d. A detailed analysis that compares the profiles of two or more choice targets to each other.

22. A computerized choice guidance method wherein the choices are about at least one of careers/vocation, apartments, cars, and other multiple choice targets with multiple aspects, except for computer-dating, comprising at least one of:
a. Giving the user immediate feedback about the results of his choices at intermediary stages even when using a compensatory method.
b. Taking into consideration also the core-ness of the aspects for the choice targets.
c. Allowing the user also to define at least one of “OR” and “If relationships among aspects.

23. The method of claim 22 wherein this immediate feedback is accomplished by letting the user view after at least one of {filling each aspect, filling a group of aspects, making changes in aspects, and changing their importance}, the resulting list of most compatible choice targets according to the aspects already filled by him.

24. The method of claim 22 wherein in order to get more meaningful results from the start the aspects are also ordered in advance, at least partially, by at least one of: Descending order of importance, descending order of core-ness, and other criteria.

25. The method of claim 24 wherein this pre-ordering is done by at least one of:
a. Asking the user to specify the importance in advance at least for the more important aspects in his eyes.
b. If the user is only asked to define the importances, the ranking is generated automatically from the importances as defined by the user and/or by taking into account also known importances from previous statistics and/or previous users, at least for internal sorting among aspects to which the user gave the same importance.
c. Asking the user to rank in advance the aspects, like in the sequential elimination, except that at each step compensatory rules are used instead of elimination, except for aspects where the user marked absolute importance.
d. Automatically ordering the aspects in advance according to their already known importances.
e. Automatically ordering aspects according to at least one of known correlations with success and/or with satisfaction and/or additional contribution of each aspect after the previous aspects, and/or other statistics.
f. Automatic ordering of the aspects by using core-ness data, so that aspects are pre-ordered in descending order of core-ness, so that each aspect is positioned according to at least one of: the number of choice targets in which it is a core aspect, and its sum of core-ness across choice targets.
g. The variation in the characterizations of each aspect across choice targets is taken into account when automatically ordering aspects, so that aspects that have a more distinctive value appear before aspects with less distinctive value.
h. High core-ness aspects that are also more differentiated among choice targets and are therefore more distinctive are ordered before high core-ness aspects that are less distinctive.

26. The method of claim 22 wherein at least one of the following features exist regarding the core-ness:
a. The core-ness of aspects across choice targets is used for aiding at least partially in the ordering process of aspects for sequential elimination.
b. The core-ness of aspects across choice targets is used at least as part of the weight formula for scoring the level of matching of each choice target to at least one of the user's preferences and any other relevant matching criteria.
c. The core-ness of aspects within each choice target is used at least as part of the weight formula for scoring the level of matching of that choice target to at least one of the user's preferences and any other relevant matching criteria.
d. Only the core-ness is used instead of the user specified importances.
e. A combination of core-ness and user importances is used.
f. The core-ness of aspects across choice targets is used at least partially for changing the strictness level of the matching requirements in each aspect.
g. The core-ness of aspects within each choice target is used at least partially for changing the strictness level of the matching requirements in each aspect.
h. The user is allowed to use absolute weights only in aspects which have high core-ness across choice targets.
i. The core aspects for each choice target are determined by at least one of asking career-counseling experts, asking people who work in each choice target, and various statistics.
j. The core aspects for each choice target are determined automatically.
k. The core aspects for each choice target are determined automatically, based on aspects with centers of weights near the positive extreme of the scale.
l. The core-ness rating of each aspect for each choice target is at least one of binary and a larger scale.
m. The core-ness score of an aspect across choice targets is computed as the number of choice targets in which the aspect is considered a core aspect.
n. The core-ness scores and/or the sorting according to core-ness take into consideration at least partially also the level of agreement between and/or within various sources when determining the characterization of the choice target on the aspects, wherein said sources are at least one of experts, people who work in the choice target, and various statistics.
o. The core-ness score of an aspect across choice targets is computed as the sum of core-ness scores of the aspect across choice targets.

27. The method of claim 22 wherein the level of matching in each aspect in each choice target is based on at least one of:
a. The overlap in acceptable and optimal levels.
b. The size of and/or directions of the gap in at least one of the centers of weights and the borders between the user's preferences and the choice target's characterization in each aspect.
c. The number of matching options in each aspect.

28. The method of claim 22 wherein at least one of the following features exist:
a. In the compensatory method the user is allowed to control the ratio between high importance to low importance and/or to define this also for at least some of the intermediary values.
b. In the compensatory method automatically a number of different ratios between high importance to low importance is used and in the top list are displayed choice targets that appeared at the top list across the different ratios.
c. The user is allowed to choose if he/she wants the scoring of choice targets to be more or less strict.
d. The user can choose if he/she wants at least one of more focused or small lists at the end, or more heterogenous or larger lists.
e. The user can choose the requested size of the final list of choice targets, at least one of: In advance and During the process.
f. When using compensation the list size of most compatible choice target can be limited by at least one of a minimum and a maximum value, and the exact size is determined according to some absolute and/or relative criteria of score level.
g. The user can specify more than 2 levels of acceptability.

29. The method of claim 28 wherein choices of desired strictness and/or desired heterogeny can be used when taking into consideration the gap in the centers of weights between the user's preference and the choice target's characterization in each aspect.

30. The method of claim 22 wherein “OR” relationships between aspects can be defined by at least one of:
a. Marking a group of questions together with a common mark.
b. Numerically defining sets.

31. The method of claim 22 wherein “IF” relationships between aspects can be defined by at least one of:
a. Letting the user graphically connect certain different variations of filling a certain question with certain options in another question.
b. Allowing the user to define sets of “If then” sentences.

32. The method of claim 22 wherein there is a more integral combination between sequential elimination and compensation, by at least one of:
a. Starting with elimination, but adjusting the scores automatically to compensation at least partially, if too few choice targets are left after only a small part of the aspects has been used.
b. Allowing the user freedom to decide at each step of the sequential elimination (regardless of the number of remaining choice targets) if he/she wants to continue with the sequential elimination or to transfer directly to compensation.
c. Letting the user choose if to apply compensation only for the remaining aspects that have not yet entered the process, or to apply it to all the aspects from the beginning.
d. Letting the user choose if to apply the compensation to all the choice targets or only to those remaining after the elimination.
e. Entering into the elimination only aspects for which the user entered absolute importance, and after these aspects are finished automatically switching to compensation
f. Allowing the user at any stage of the process to decide to translate everything between compensation and elimination, so that the list of remaining choice targets is updated to have been based on compensation from the start or to have been based on elimination from the start.

33. The method of claim 22 wherein the user's answers are automatically analyzed during filling the questionnaire, in order to check the quality of his/her answers.

34. The method of claim 33 wherein at least one of the following features exist:
a. The user is given feedback if the answers are not reasonable enough, at least one of: During the filling process, After he/she has finished it, and at least after various stages have been completed.
b. The user is confronted with non-trivial discrepancies between his rating of the importance of the aspects and his ranking of the aspects if both rating and ranking are used.
c. At least one of the user's differentiation, consistency, and coherence can be automatically analyzed.
d. The user can be warned if he/she gives too many aspects absolute or high weight or gives too many aspects weight 0.
e. If there is a significant discrepancy between the weights chosen by the users and the actual core-ness of the aspects, the user can be advised about this.
f. Feedback for such automatic analysis is given to the user at least one of: During his filling them and In general across aspects.

35. The method of claim 22 wherein the quality of the process may also be automatically analyzed.

36. The method of claim 35 wherein if the user wants to use only a few of the options or end the process too soon he is advised about it.

37. The method of claim 22 wherein the quality of the output is automatically analyzed.

38. The method of claim 37 wherein the level of homogeneity or heterogeneity of the resulting choice targets is automatically analyzed and brought to the user's attention.

39. The method of claim 22 wherein automatically the user is also given a list of occupations that were dropped out because of just one aspect.

40. The method of claim 39 wherein in compensation that aspect can be any aspect in which absolute weight was used.

41. The method of claim 22 wherein it is automatically analyzed which aspects have caused at least one of most of the lowering of scores or dropping out of choice targets, and these aspects are displayed to the user in descending order of how much they affected the process.

42. The method of claim 22 wherein the user is allowed to get for any choice target an analysis of at least one of:
a. Which aspects most affected the fit with that choice target.
b. What is the ordinal score of the requested choice target compared to other choice targets in terms of fitting the user's requirements.
c. A list of similar choice targets to any choice target and to chose if to base the similarity on at least one of the core aspects of each choice target or on his own rating of importances or core-ness of aspects across choice targets or any combination of the above.
d. A detailed analysis that compares the profiles of two or more choice targets to each other.

43. The system of claim 1 wherein at least one of the following features exists:
a. The aspects are at least partially sorted according the average importance given by previous users.
b. The matching scores for each aspect take into consideration at least partially also the average importance given to that aspect by previous users.
c. A choice target can be dropped out during the elimination process only if the aspect used at that stage is a core aspect in that choice target.
d. The ratio of weights is stated explicitly while the user is filling the weights so that he/she can take that into account.
e. The weights are numerically labeled and represent the actual literal relations among them and this is explicitly explained to the user so that he/she can take this into account.

44. The method of claim 22 wherein at least one of the following features exists:
a. The aspects are at least partially sorted according the average importance given by previous users.
b. The matching scores for each aspect take into consideration at least partially also the average importance given to that aspect by previous users.
c. A choice target can be dropped out during the elimination process only if the aspect used at that stage is a core aspect in that choice target.
d. The ratio of weights is stated explicitly while the user is filling the weights so that he/she can take that into account.
e. The weights are numerically labeled and represent the actual literal relations among them and this is explicitly explained to the user so that he/she can take this into account.

45. The system of claim 1 wherein generating the ratio of weights takes into account at least one of:
a. Average ratios generated from previous users.
b. Data about the correlation of various ratios with at least one of work satisfaction, status, level, success, and satisfaction from the employee.
c. The ratio desired by the user.
d. Various characteristics of the distribution of weights used by the user.

46. The method of claim 22 wherein generating the ratio of weights takes into account at least one of:
a. Average ratios generated from previous users.
b. Data about the correlation of various ratios with at least one of work satisfaction, status, level, success, and satisfaction from the employee.
c. The ratio desired by the user.
d. Various characteristics of the distribution of weights used by the user.

47. The system of claim 1 wherein during compensation at least one of marks, colors, separate grouping into sub-lists, numerical report, and statistical indication are used to indicate to the user at least one of the additions and deletions in the top list at the last step and which choice targets have been most stable on the list already for a number of steps.

48. The method of claim 22 wherein during compensation at least one of marks, colors, separate grouping into sub-lists, numerical report, and statistical indication are used to indicate to the user at least one of the additions and deletions in the top list at the last step and which choice targets have been most stable on the list already for a number of steps.

49. The system of claim 1 wherein at least one of the following features exists:
a. During the compensation method the user is given feedback on the results of his choices at at least one of the following: after every few aspects, each time there is a significant change in the list, and at any step but only if and when the user requests it.
b. At any stage of the process the user can decide to translate everything from elimination to compensation, so that an elimination list of remaining choice targets can be instantly transformed to have been based on compensation from the start, thus becoming a list of top matching choice targets.
c. At any stage of the process the user can decide to translate everything from compensation to elimination, so that a list of compensatory top matching choice targets can be instantly transformed to have been based on elimination from the start.
d. The user can go back and forth in the steps of adding the aspects and view each previous stage as if it was made according to compensation or according to elimination, regardless of the way it was actually done before.
e. At any stage after filling an aspect the user can for instantly view both the list based on elimination and the list based on compensation.
f. At any stage after filling an aspect the user can view a combined list showing the top list by compensation with highlighting of the choice targets that remain also according to elimination.

50. The method of claim 22 wherein at least one of the following features exists:
a. During the compensation method the user is given feedback on the results of his choices at at least one of the following: after every few aspects, each time there is a significant change in the list, and at any step but only if and when the user requests it.
b. At any stage of the process the user can decide to translate everything from elimination to compensation, so that an elimination list of remaining choice targets can be instantly transformed to have been based on compensation from the start, thus becoming a list of top matching choice targets.
c. At any stage of the process the user can decide to translate everything from compensation to elimination, so that a list of compensatory top matching choice targets can be instantly transformed to have been based on elimination from the start.
d. The user can go back and forth in the steps of adding the aspects and view each previous stage as if it was made according to compensation or according to elimination, regardless of the way it was actually done before.
e. At any stage after filling an aspect the user can for instantly view both the list based on elimination and the list based on compensation.
f. At any stage after filling an aspect the user can view a combined list showing the top list by compensation with highlighting of the choice targets that remain also according to elimination.

51. The system of claim 1 wherein the user is asked what choice target alternatives he/she is already considering, and then automatically the system analyzes and reports to the user at least one of how similar the resulting choice targets are to the alternatives the user mentioned, how many of them are included in the list, why those that do not appear in the final lit did not enter them, or, in case of compensation, the serial position in terms of compatibility each of them has compared to the other choice targets.

52. The system of claim 1 wherein in the compensation the user is given at least one of:
a. Separately a list in which the matching is based more on the user's importances and a list based more on the core-ness of aspects.
b. A combined list which shows only the choice targets that appeared on the top of both a list based on importances and the list based on core-ness.
c. A list based on importances in which the choice targets that appear also on the list based on core-ness are highlighted.
d. A list based on core-ness in which the choice targets that appear also on the list based on importances are highlighted.

53. The system of claim 1 wherein at least some of these features can be used also in addition or instead for at least one of:
a. Matching users with specific job offerings.
b. Choosing a university or college.
c. Buying or renting a car.
d. Buying or renting an apartment or house.

54. The system of claim 53 wherein the users are first helped to decide what types of jobs or apartments or cars are good for them or suit their needs in general, without matching with a specific apartment or car or job offering, and afterwards the user's preferences are matched also with specific offerings.

55. The system of claim 54 wherein the same profile of aspects filled by the user can be used also for the second stage of matching with specific offerings, and/or the user is asked to fill some additional aspects for the matching with specific offerings.

56. The method of claim 22 wherein at least some of these features can be used also in addition or instead for at least one of:
a. Matching users with specific job offerings.
b. Choosing a university or college.
c. Buying or renting a car.
d. Buying or renting an apartment or house.

57. The method of claim 56 wherein the users are first helped to decide what types of jobs or apartments or cars are good for them or suit their needs in general, without matching with a specific apartment or car or job offering, and afterwards the user's preferences are matched also with specific offerings.

58. The method of claim 57 wherein the same profile of aspects filled by the user can be used also for the second stage of matching with specific offerings, and/or the user is asked to fill some additional aspects for the matching with specific offerings.
